(19) United States
(12) Patent Application Publication
(10) Pub. No.: US 2009/0319537 A1
(43) Pub. Date: Dec. 24, 2009

(54) Method And System of Using Structured Social Networks and Communities to Create And Maintain Relationships Between Configuration Items in a Configuration Management Database

(76) Inventors: Kurt Westerfeld, Ashburn, VA (US); Adam Cusson, Bristow, VA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/488,391

(22) Filed: Jun. 19, 2009

Related U.S. Application Data
(60) Provisional application No. 61/079,126, filed on Jul. 8, 2008.
(60) Provisional application No. 61/074,074, filed on Jun. 19, 2008.

(51) Int. Cl. G06F 17/30; G06F 7/00

(52) U.S. Cl. 707/10; 707/104.1; 707/102; 707/E17.032; 707/E17.044

(57) ABSTRACT

A method is described for using social networks of communities within a large enterprise to establish relationships between configuration items in a configuration management database, and to maintain the information about these relationships as changes are made in the information technology environment of the enterprise. Communities made up of groups of individuals are associated with groups of one or more configuration items, permissions are established for the actions of create, modify, delete, update, comment, tag and mark configuration item relationships, and means are provided for members of a Community to search for or browse configuration item relationships and operate on CI and CI relationships in a continually iterative model.

### RELATED APPLICATIONS

This application claims priority from U.S. Provisional Patent Application No. 61/079,126 titled “Method of Using Structured Social Networks and Communities to Create and Maintain Relationships Between Configuration Items in a Configuration Management Database” filed on Jul. 8, 2008, and from U.S. Provisional Patent Application No. 61/074,074 titled “System and Method for Using a Collaborative Network to Maintain a Configuration Management Database” filed on Jun. 19, 2008.

This application is related to U.S. Patent application Ser. No. xx/xxx,xxx for “Method And System of Using Social Networks and Communities to Ensure Data Quality of Configuration Items in a Configuration Management Database” and U.S. patent application Ser. No. xx/xxx,xxx for “Method and System of Using Structured Social Networks and Communities to Create and Maintain Business Service Models”, both filed contemporaneously herewith and incorporated by reference herein.

### BACKGROUND OF THE INVENTION

1. Field of the Invention

The present invention relates to information technology (IT) systems and more specifically, to methods and apparatus for ensuring that accurate and current data about relationships between Configuration Items (CIs) exists in a Configuration Management Database (CMDB) by applying social network and community data management principles.

2. Background Description

IT organizations manage large and complex IT environments to provide a plurality of services to their internal and external customers. The large scale of these environments produces a large volume of configuration information that must be tracked in order to manage the IT environment. This configuration data is typically stored as Configuration Items (CIs) and CI attributes as part of a larger Configuration Management Database (CMDB). The complexity manifests itself not only as data about the CIs themselves, but also as relationships between the CIs. This relationship information contained in a CMDB is a critical part of managing the IT environment since it allows IT staff to proactively model the impact of planned changes, while also allowing for lower mean time to resolution (MTTR) of unplanned outages.

A typical CMDB is made up of one or more hierarchical structures of CIs and their attributes with a number of disparate data sources all being combined to populate the CMDB. These data sources can include (but are not limited to) asset management systems, performance monitoring systems, trouble ticketing systems, service desk solutions, and manual user maintained data sources (e.g. spreadsheets). This information generally reflects information about the CIs themselves but rarely does it provide insight into the relationships between the CIs. In most IT organizations, this information resides in widely spread documents, scattered diagrams, and in the memory of subject matter experts in the organization.

The end result is that most IT organizations face challenges associated with having no central repository of clear, accurate, reliable, and readily available information about relationships and dependencies between IT elements. These challenges include the inability to fully understand the impact and scope of any proposed changes/maintenance work on the IT environment, or to quickly understand the impact of any operational failures in the environment.

### SUMMARY OF THE INVENTION

In order to overcome the above described problems with assembling into one place readily available information about relationships and dependencies between elements in an IT system, the present invention organizes and distributes the work among those within the organization closest to, and most knowledgeable about, these relationships and dependencies.

Social networking applications have in recent years proliferated. Typically, a social network application facilitates construction of a social network of members connected by a common purpose. For example, members interested in developing a network of business contacts may participate in a network designed for that purpose. Very particular purposes may support a social network, such as travelers with layovers as described in U.S. Patent Publication No. 2009/0077061 to Abercrombie et al. A variety of applications have been developed to provide services to enhance the operation of such networks. For example, Internet based merchandisers may use social networking techniques to add value to shopping experiences by sharing product reviews with network friends as described in U.S. Patent Publication No. 2009/0070228 to Ronen.

Social networks may feature methods for determining social distance between members based on attributes provided by the members. These attributes may also be used to target advertising to members as described in U.S. Patent Publication No. 2009/0112701 to Turpin et al. or, in combination with social distance, may be used to present content to a member as described in U.S. Patent Publication No. 2009/0070700 to Johanson. Methodologies have been devised for one member of a social network to upload content, such as a picture, about another member, as described in U.S. Pat. No. 7,117,254 to Lunt et al.

There are also applications which use social network techniques to address problems that do not, in themselves, have anything to do with social networks. For example, U.S. Patent Publication No. 20090070168 to Thompson et al. describes a system for monitoring the use of electrical power by consumers, where information collected by various measuring devices is shared with a social network of experts. However, there are no prior art uses of social network techniques applied to the above described problems with assembling into one place readily available information about relationships and dependencies between elements in an IT system.

A Configuration Management Database (CMDB) is comprised of large numbers, potentially in the millions, of Configuration Items (CIs). A CI is an entity in the CMDB that contains attributes describing a physical or logical object, as will be further described below in connection with FIG. 1. Usage and utility of the CMDB is dependent on the accuracy of relationships between CIs, and maintaining a high degree of accuracy is a constant challenge when deploying a CMDB in a large enterprise.

Social networks within a large enterprise, made up of interconnected individuals and groups of individuals (communities), are then associated with groups of one or more CIs. This associative behavior is used to drive creation and maintenance of relationships among all the CIs in the CMDB. The social networking and communities approach serve the purpose of distributing the tasks of initially establishing the relationships between CIs in the CMDB, as well as distributing the tasks of maintaining this information as changes continue to be made in the IT environment.

Building and maintaining currency of CI relationships in a CMDB can best be achieved by providing IT staff and other subject matter experts with a mechanism by which they establish and operate as groups of individuals who own responsibility for validating and maintaining CIs and their relationships. In view of the large number of configuration items and relationships in a typical CMDB, this mechanism can only be implemented by computer. This invention describes the process by which individuals associated with one or more Communities (which contain CIs) can create and help maintain relationships between CIs which may or may not reside in the same Community. Members of the Communities can search for or browse CI relationships and view, update, delete, tag, comment on, or generate reports on CI relationships. A CMDB would have an overlapping social network of Communities, CIs, and individual users whose combined efforts will result in creating, validating, and maintaining relationships between CIs.

Administrators of the system construct Communities which represent groups of individuals, groups of CIs, and properties of CIs including their relationships to other CIs. The Communities also contain permissions which allow/disallow individuals from performing one or more sets of actions including (but not limited to) read, create, modify, delete, update, tag, mark, and comment upon relationships of CIs.

The method by which CIs can be associated within Communities is dependent on the underlying CMDB implementation and may vary significantly for each deployment. For example, an initial mapping of CIs to Communities could be defined based on grouping classes of CIs into each Community. In a different deployment scenario, administrators may choose to associate CIs with Communities based on a naming convention or an attribute that defines physical locations.

A computer based environment is provided to individual users where they can view information about any given CI in a Community, including a history of changes that have been made to it. In addition, individuals can choose to add any missing CIs, missing CI attributes, or CI relationships. Dated CIs, CI attributes, or CI relationships can similarly be deleted. Should any incorrect information be discovered, users have the option of either updating the CI relationship, or tagging the information for update by another member of the Community. Updates can either be automatically approved or go through an approval process prior to being committed into the CMDB.

Members of the Community are given methods, implemented via suitable software display interfaces, by which they can view all CIs and CI relationships that have been tagged. This allows all members of the Community to contribute their expertise towards improving the overall quality of CI relationships in the CMDB.

Community oriented workspaces are provided to facilitate the process by which members of that Community can track activities taking place on contained CI relationships, including highlighting recently updated CI relationships, CI relationships requiring updates, CI relationship updates requiring approvals, new CI relationships added, and CI relationships deleted. Individuals are also provided with workspaces to facilitate their interaction with multiple Communities that they might be members of. Activities taking place within each Community are summarized for each individual user.

By distributing CIs across Communities and providing computer implemented mechanisms by which members of the Communities can search, view, and operate on CI and CI relationships in a continually iterative model, IT organizations can rely on CI relationships (and thus the CMDB itself) to stay accurate and current and realize the full value of their CMDB implementations for change impact analysis and understanding the impact of outages.

It is therefore an aspect of the present invention to provide a computer implemented method of managing the quality of CI relationship data contained in a CMDB where the CMDB itself exists in either a single database, a distributed loosely coupled database, or a federated series of database, wherein a computer implemented application allows individual users within Communities to perform the functions of creating CI relationships, editing CI relationships, deleting CI relationships, marking CI relationships as inaccurate, marking CI relationships as accurate, marking CI relationships as incomplete, associating varying levels of importance to CI relationships, and viewing history of changes of CI relationships.

Further aspects of the invention include: computer implemented social network(s) comprised of individual users with assigned roles granting permissions for any combination of creation, modification, deletion, update, comment, tagging, and marking of CI relationships; communities comprised of groups of these individuals with community permissions for any combination of creation, modification, deletion, update, tagging, and marking of CI relationships; a set of one or more CIs associated with each community.

Another aspect of the invention is a computer implemented method wherein individuals can create CI relationships within a community, should the permissions defined for the individuals allow them to do so. It is also an aspect of the invention to provide a computer implemented method wherein individuals can modify CI relationships within a community should the permissions defined for the individuals allow them to do so.

Yet another aspect of the invention is a computer implemented method wherein individuals having the necessary permissions can tag CI relationships within a community. Tags can be assigned an arbitrary value, including but not limited to: “Inaccurate”, “Needs to be updated”, “To be decommissioned”. Searches can be conducted of all CI relationships which have been tagged with any of these arbitrary values. Members of a community can perform operations such as report generation, browsing, sorting on all CIs relationships.

It is also an aspect of the invention to provide a computer implemented method wherein individuals can take one or more of the actions for which they have permission and apply them to a subset of CI relationships generated by report generation, browsing, or sorting. The method also includes tracking full details and history of tasks described in these actions for any and all CI relationships in the CMDB, and generating graphical and text reports containing some or all of this tracking information. Such graphical and text reports for any CI relationships can be viewed by any individual having the necessary permissions.

Yet another aspect of the invention is a computer implemented method for associating a community based perspective with each of the foregoing methods, that is, filtering displays associated with the foregoing methods so that the relationships between and among CIs are highlighted such that the display of data makes evident the information owned by, and relationships among, different communities.

Community activity, such as relationship creation, update, or removal, are presented to community members as a time-ordered event display intended to draw participants together with the goal of improving data quality of relationships. This allows all members of the Community to contribute their expertise towards improving the overall quality of data in the CMDB.

The implementation of the invention described herein provides a method and system for managing the quality of configuration item relationship data in a configuration management database of an enterprise, the computer being used to create—or enable the creation of—one or more communities, each community associating configuration items (CIs) and individuals related by one or more applications, each individual associated with a community having particular expertise within the enterprise with respect to one or more of the applications or one or more of the configuration items associated with the community. The computer also enables an individual in the community to view the configuration items in the community and view a map of relationships connecting one or more of the configuration items, and enables the individual to perform operations on the mapped relationships. These operations are then displayed to other individuals associated with any community containing one or more of the configuration items connected by the mapped relationship.

The mapped relationships may include logical groupings of configuration items, as well as physical connections between configuration items. In the latter case, a mapped relationship may be updated by changing a source or destination component of the relationship.

In another aspect of the invention, hierarchical relationships may be established among key configuration items. Further, the computer may perform the further step of enabling a mapping of permissions for individuals to perform operations on configuration relationships. These operations may include creation, modification, deletion, updating, tagging, and marking of CI relationships.

In a further aspect of the invention the computer enables the individual to tag a relationship for review by one of a) another individual associated with the community, b) a role associated with the community, or c) another community that has a shared interest in a configuration item participating in the relationship. In addition, with respect to such a tagged review, the computer may also ensure that the review is itself reviewed prior to committing the operation into the configuration management database.

Another aspect of the invention is using the computer to provide workspaces to facilitate the work being done to maintain relationship data. These workspaces may include a community workspace enabling individuals associated with the community to monitor operations being performed on relationships. They may also include individual workspace enabling the individual to monitor and operate on relationships in each community with which the individual is associated.

Declared interest groups in the form of Communities applying the foregoing methods to a CMDB will result in higher data quality by leveraging the group knowledge in the distribution of the tasks of evaluating and updating CI relationships contained within the CMDB. As CI relationships are created/modified/deleted/flagged, these changes are broadcast as a stream to all subscribed Community members encouraging them to review and make changes to the information as needed.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a sample IT environment illustrating CIs and CI relationships.

FIG. 2 is a schematic diagram showing how individuals and CIs are allocated to form communities, and illustrating relationships between CIs.

FIG. 3 is an exemplar flow chart showing how application of social networking and community methods in accordance with the invention improve management of CI relationships.

### DETAILED DESCRIPTION OF A PREFERRED EMBODIMENT OF THE INVENTION

In a typical IT organization, one of the most challenging tasks is managing and tracking the relationships between a varied mix of infrastructure, applications, services, physical locations and logical structures (e.g. lines of business, clusters, etc.).

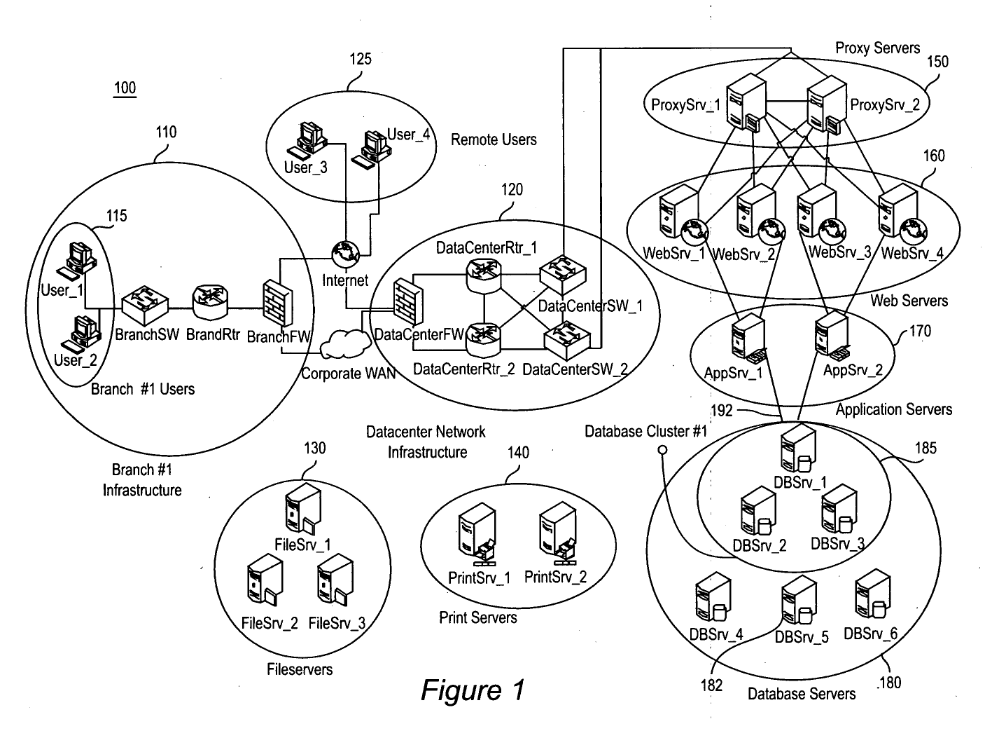

Referring now to the drawings, and more particularly to FIG. 1, there is shown a sample environment, relationship map 100, which an IT organization is responsible for managing. A CMDB has been constructed to hold detailed information about each of the elements, and including the logical ones such as Proxy Servers 150, Web Servers 160, and Branch #1 Infrastructure 110. Note that the Remote Users 125 and Branch #1 Users 115 are also shown. For each of the physical and logical CIs, there are individuals or groups who have access to information about the CIs themselves. Communities are established to group together the CIs with the individuals who may either be responsible for maintaining information about the CIs, or those who are interested in generating reports/searching for key information.

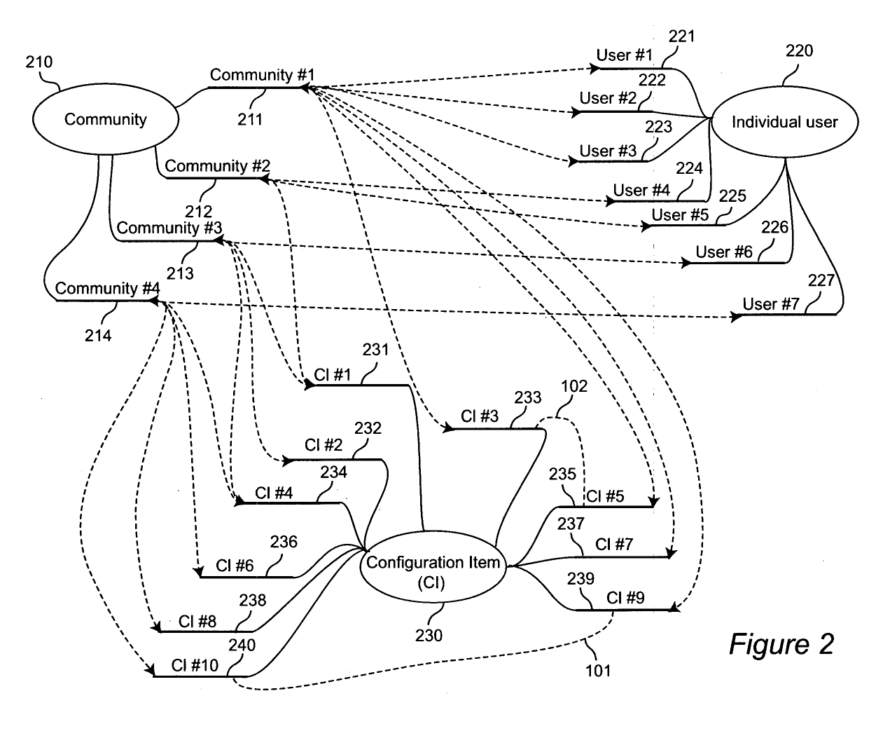

It should be noted from FIG. 2 that a CI or individual may be associated with multiple communities, and each CI may have multiple relationships in which it participates. Further, an individual may have a particular role within a community, or share a particular role with other individuals. Thus, for example, if a relationship involving a particular CI is observed by a member of one community as needing review, it may be tagged for review by another member of the same community, or tagged for review by a particular role within the community, or tagged for review by another community having an interest in one or another of the the particular CIs involved in the relationship.

Individuals within Communities are provided with a computer implemented method by which they can construct and maintain relationships between all the CIs. For example, members of the web management team would choose to establish a relationship between WebSrv_{—}1, WebSrv_{—}2, WebSrv_{—}3, and WebSrv_{—}4 and name it Web Servers 160. Relationships would similarly be established for the Proxy Servers 150 (ProxySrv_{—}1 and ProxySrv_{—}2), Application Servers 170 (AppSrv_{—}1 and AppSrv_{—}2), Database Servers 180 (DBSrv_{—}1, DBSrv_{—}2, DBSrv_{—}3, DBSrv_{—}4, DBSrv_{—}5, and DBSrv_{—}6), Print Servers 140 (PrintSrv_{—}1 and PrintSrv_{—}2), and File Servers 130 (FileSrv_{—}1, FileSrv_{—}2 and FileSrv_{—}3). Relationships are also indicated by connections between CIs, for example, AppSrv_{—}1 may be connected to Database Cluster #1 185 by a physical (rather than a logical) relationship 192 that may be named “connected to”. Such relationships may be updated by changing the source or destination component of the relationship. For example, AppSrv_{—}1 may suffer an outage and be replaced by a new AppSrv_{—}3, and this would be reflected in an update to mapped relationship 192, and corresponding updates to other connections (not labeled in FIG. 1) to AppSrv_{—}1 and perhaps also to Database Cluster #1 185 or the Database Servers (DBSrv_{—}1, DBSrv_{—}2 and DBSrv_{—}3) therein.

There may be relationships established that build on previously established ones. An example of this would be a relationship named “Datacenter Servers” which would include all of the Server relationships. Subset relationships could also be established—Database Cluster #1 185 would be a set of CIs where the relationship is defined as a subset of the Database Servers 180.

Application owners may choose to establish hierarchical relationships between key CIs for their Communities. An example of this would be a relationship named “Online Banking” involving Web Servers 160, Application Servers 170, and Database Cluster #1 185. One of the most difficult challenges associated with relationship mapping is ensuring that the defined relationships are both complete and continue to stay up-to-date. In this example, the Online Banking Application Community may believe that they have a complete relationship map established for their application. However, as FIG. 1 illustrates, there are CIs such as the Proxy Servers 150 and Datacenter Network Infrastructure 120 that appear to have physical connections to the Web Servers 160 but which are not accounted for in the initial representation of the relationships for this application.

To address this challenge, a computer implemented method is provided whereby a member of a Community (based on assigned permissions) can tag information as being incomplete, make changes to include any missing CIs in the relationships, update relationships that others have tagged, or delete obsolete or incorrect relationships. Examples of this would include:
Network administrator could build the initial Datacenter Network Infrastructure 120 relationships and then associate them with all applications in the Datacenter, including the earlier Online Banking example.
Web server administrator could tag or make a comment that Proxy Servers 150 are missing from the defined relationships for Online Banking.
Another web server administrator would note the tag and add the Proxy Servers 150 relationships to On line Banking.
If the initial definition of the Online Banking incorrectly included DBSrv_{—}5 182, a database administrator could note that this application uses Database Cluster #1 185 and since DBSrv_{—}5 182 is not part of that cluster, it should be removed from the relationship.

FIG. 2 describes the infrastructure provided by the computer implemented methods described in this invention. It illustrates the relationships between CIs 230, Communities 210 and Users 220. A CI 230 can belong to one or more communities 210 with a subset of its attributes being maintained by each community. Configuration items #3 233, #5 235, #7 237 and #9 239 belong to Community #1 211. Configuration item #1 231 belongs to both Community #2 212 and Community #3 213. Configuration item #2 232 belongs to Community #3 213, and Configuration item #4 234 belongs to both Community #3 213 and Community #4 234. Configuration items #6 236, #8 238 and #10 240 belong to Community #4 214.

Individual users 220 can be associated with one or more Communities and therefore with one or more CIs. For example, as shown in FIG. 2, three users (User #1 221, User #2 222 and User #3 223) are associated with Community #1 211. Users #4 224 and #5 235 are associated with Community #2 212. Users #6 226 and #7 227 are associated with Community #3 213 and Community #4 214, respectively.

These associations form the core of the social network upon which this invention builds. The end goal is to take the traditionally monolithic CMDB and separate it into Communities 210 where related CIs 230 and IT staff (individual users 220) with specialized knowledge pertaining to these CIs can be brought together for the purpose of validating and updating CI relationships. These relationships are shown in relationship map 100 in FIG. 1. The schematic form of FIG. 2 does not permit a comprehensive display of the relationships between and among CIs. However, exemplars of these relationships are indicated by the relationship 101 connecting CI 240 and CI 239, and the relationship 102 between CI 233 and CI 235. Note that relationship 102 connects CIs within the same community 211, whereas relationship 101 connects CIs from different communities (211 and 214). This feature—that relationships may span communities—is well suited to the capabilities of social networks, as these capabilities are used in the present invention, as further demonstrated below.

Each member of a community that has an association with, or interest in, a CI in a mapped relationship can help assure that the relationship maps are up-to-date, either by directly manipulating the data, or by annotating and flagging quality issues with the data. What the invention does is make sure that other members are advised of these contributions, via a chronological feed that is filtered to suit the CI association and interest of the other members.

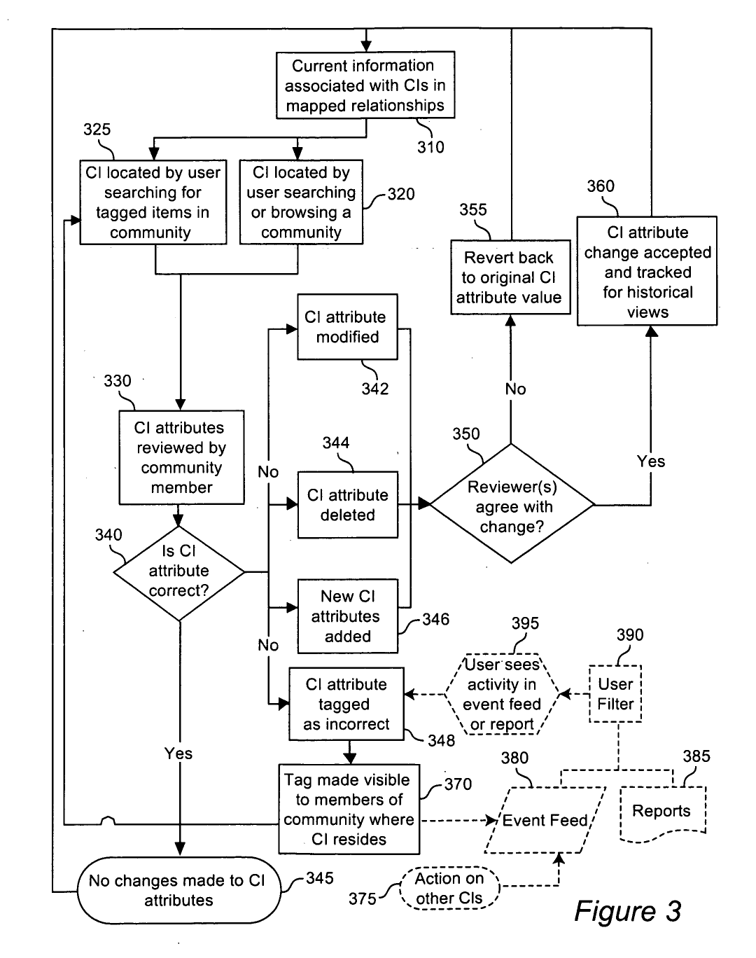

FIG. 3 is a flowchart which illustrates an example of the process by which the core aspects of this invention are applied in an iterative fashion to achieve accuracy and currency of data describing relationships between and among CIs in the CMDB. Those skilled in the art will appreciate that the invention can be implemented using other processes varying in structure and detail yet enabling the same collaborative review and maintenance of the accuracy of relationship data for CIs in a CMDB.

In the situation described in FIG. 1, the relationship 192 between AppSrv_{—}1 and Database Cluster #1 reflects a certain allocation of database server resources to applications being serviced by AppSrv_{—}1. In principle, the relationship map 100 of FIG. 1 shows all relationships connecting CIs of the enterprise. In practice, actual display views of the complete relationship map will show a filtered view tailored to the interests of a particular community 210 or individual 220.

Item 310 in the flowchart of FIG. 3 represents the current information in such a filtered view. For the purposes of illustration, suppose that AppSrv_{—}1 has an outage and is replaced by AppSrv_{—}3 (not shown in FIG. 1). Suppose further that the outage of AppSrv_{—}1 is published on event feed 380. A community member having an interest in AppSrv_{—}1 will observe this event 395, perhaps from a report 385 tailored by user filter 390. This community member may then tag 348 the CI for AppSrv_{—}1 as incorrect. In Step 325, CI AppSrv_{—}1 is located by a user searching for tagged items in the relevant community. The user reviews the attributes of the CI in step 330, and asks at step 340 whether the relationship 192 indicated on relationship map 100 is correct. Upon inquiry, the replacement of AppSrv_{—}1 by AppSrv_{—}3 will be uncovered by the user, and the relationship 192 will be updated by deleting 344 AppSrv_{—}1 and adding 348 AppSrv_{—}3. In general, relationship updates involve either deletion 344 or addition 346, and not a modification 342. If the tagging had been in error, then the user would have seen 340 that the relationship 192 was correct, and that no change was necessary, as indicated in step 345.

Users in the Community who have the reviewer role exercise their role at step 350, and are notified by viewing the overall event feed 380 for the community which indicates the flagging activity by the original user, or are directly routed the flagging activity into a computer-generated inbox. These community reviewers 350 either accept the deletion 344 and addition 346 as being correct at step 360, thereby removing an error in the CMDB, or cause the modified attribute to revert back to its original value at step 355.

Further iterations of the workflow may expand upon the consequences of the outage of AppSrv_{—}1 and replacement by AppSrv_{—}3. The replacement may have involved reconfigurations of workload requiring updates in additional mapped relationships. In accordance with the social network concept underlying the invention, such consequences will be uncovered more rapidly and more reliably by distribution of responsibility to communities as described in FIG. 2. Note that the triggering of corrective action by tagging 348 is not limited to those members and communities most directly responsible for a CI that is the subject of a notation on the event feed 380. A user in a community responsible for another CI having a relationship with the CI noted on the event feed 380 may be interested because of the relationship. Also the event feed 380 records actions taken 375 on other CIs, and one of these other CIs may have a relationship that, upon review by an interested user, results in the same tagging 348.

The effects of distribution of interests and work throughout the community may be further illustrated with reference to FIG. 3. Actions such as CI tagging 348 are published 370 to other members of the community (or communities) where the CI resides. As indicated above, this visibility may be accomplished by adding the action to a time-ordered event display such as event feed 380. Other members of the community (or other communities) who have an interest in this CI may have their attention drawn 395 to it by use of filters 390 and reports 385 which highlight from the event feed 380 those CIs of interest. The significance of the event feed 380, and the filters 390 and reports 385 which highlight CIs of interest to particular community members, is that the event feed 380 will include actions 375 on other CIs, which may have relationships which draw user attention 395 in ways that are not anticipated by the orderly flow chart exemplar shown beginning with items 320 and 325. The capacity of social network based collaboration to proceed in unanticipated ways is a strength of the invention, and is indicated by the distinguishing dashed lines associated with items 375, 380, 385, 390 and 395. Indeed, the tagging action 348 may be generated in the first instance by user attention drawn in just this way.

As individual users are increasingly involved in the CMDB environment through the use of Community and Individual workspaces, this process is repeatedly applied to CIs and their relationships. Each iteration incrementally adds new relationships, corrects errors, and maintains existing relationships. The end result is a CMDB which contains not only CI and CI attribute data, but a rich set of relationships which can better enable an IT organization to control change both in terms of proactive planning to understand the impact of changes, as well as quickly understanding the scope of outages.

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A computer implemented method for managing the quality of configuration item relationship data in a configuration management database of an enterprise, the computer performing the steps of:
enabling creation of one or more communities, each community associating configuration items (CIs) and individuals related by one or more applications, each individual associated with a community having particular expertise within the enterprise with respect to one or more of the applications or one or more of the configuration items associated with the community;
enabling an individual in the community to view the configuration items in the community and view a map of relationships connecting one or more of the configuration items;
enabling the individual to perform operations on one of the mapped relationships; and
displaying a record of said operations to other individuals associated with communities containing one or more of the configuration items connected by the mapped relationship.

2. A computer implemented method as in claim 1, wherein at least one mapped relationship is a physical connection between two configuration items.

3. A computer implemented method as in claim 1, wherein hierarchical relationships are established among key configuration items.

4. A computer implemented method as in claim 1, wherein a mapped relationship is updated by changing a source or destination component of the relationship.

5. A computer implemented method as in claim 1, the computer performing the further step of enabling a mapping of permissions for individuals to perform operations on configuration relationships.

6. A computer implemented method as in claim 1, wherein the operations include creation, modification, deletion, updating, tagging, and marking of CI relationships.

7. A computer implemented method as in claim 1, the computer performing the further step of enabling the individual to tag a relationship for review by one of a) another individual associated with the community, b) a role associated with the community, or c) another community that has a shared interest in a configuration item participating in the relationship.

8. A computer implemented method as in claim 1, the computer performing the further step of enabling review of the individual's operation on a relationship by other individuals associated with the community prior to committing the operation into the configuration management database.

9. A computer implemented method as in claim 1, the computer performing the further step of providing a community workspace enabling individuals associated with the community to monitor operations being performed on relationships.

10. A computer implemented method as in claim 1, the computer performing the further step of providing the individual with an individual workspace enabling the individual to monitor and operate on relationships in each community with which the individual is associated.

11. A system for managing the quality of configuration item relationship data in a configuration management database of an enterprise, comprising:
means implemented by a computer supporting the configuration management database for enabling creation of one or more communities, each community associating configuration items and individuals related by one or more applications, each individual associated with a community having particular expertise within the enterprise with respect to one or more of the applications or one or more of the configuration items associated with the community;
means implemented by the computer enabling an individual in the community to view the configuration items in the community and view a map of relationships connecting one or more of the configuration items;
means implemented by the computer enabling the individual to perform operations on one of the mapped relationships; and
means implemented by the computer for displaying a record of said operations to other individuals associated with communities containing one or more of the configuration items connected by the mapped relationship.

12. A system for managing the quality of configuration item relationship data as in claim 11, wherein at least one mapped relationship is a physical connection between two configuration items.

13. A system for managing the quality of configuration item relationship data as in claim 11, wherein hierarchical relationships are established among key configuration items.

14. A system for managing the quality of configuration item relationship data as in claim 11, wherein a mapped relationship is updated by changing a source or destination component of the relationship.

15. A system for managing the quality of configuration item relationship data as in claim 11, further comprising means implemented by the computer for enabling a mapping of permissions for individuals to perform operations on configuration relationships.

16. A system for managing the quality of configuration item relationship data as in claim 11, further comprising means implemented by the computer for enabling the individual to tag a relationship for review by one of a) another individual associated with the community, b) a role associated with the community, or c) another community that has a shared interest in a configuration item participating in the relationship.

17. A system for managing the quality of configuration item relationship data as in claim 11, further comprising means implemented by the computer for enabling review of the individual's operation on a relationship by other individuals associated with the community prior to committing the operation into the configuration management database.

18. A computer implemented system for managing the quality of configuration item relationship data in a configuration management database of an enterprise, the computer system having software modules stored thereon and having a processor operable to execute the software modules, the software modules comprising:
first computer code for enabling creation of one or more communities, each community associating configuration items and individuals related by one or more applications, each individual associated with a community having particular expertise within the enterprise with respect to one or more of the applications or one or more of the configuration items associated with the community;
second computer code enabling an individual in the community to view the configuration items in the community and view a map of relationships connecting one or more of the configuration items;
third computer code enabling the individual to perform operations on one of the mapped relationships; and
fourth computer code for displaying a record of said operations to other individuals associated with communities containing one or more of the configuration items connected by the mapped relationship.

19. A computer implemented system for managing the quality of configuration item relationship data as in claim 18, further comprising fifth computer code for providing a community workspace enabling individuals associated with the community to monitor operations being performed on relationships.

20. A computer implemented system for managing the quality of configuration item relationship data as in claim 18, further comprising sixth computer code for providing the individual with an individual workspace enabling the individual to monitor and operate on relationships in each community with which the individual is associated.
